(19) United States
(12) Patent Application Publication
(10) Pub. No.: US 2007/0222438 A1
(43) Pub. Date: Sep. 27, 2007

(54) Electromagnetic flaw detection apparatus for inspection of a tubular

(76) Inventor: Dale Reeves, Cairo (EG)

Correspondence Address: EGBERT LAW OFFICES, 412 MAIN STREET, 7TH FLOOR, HOUSTON, TX, 77002, US

(21) Appl. No.: 11/387,119

(22) Filed: Mar. 23, 2006

(51) Int. Cl. G01N 27/82

(52) U.S. Cl. 324/240; 324/228

(57) ABSTRACT

An electromagnetic flaw detection apparatus for inspection of a tubular has a frame, a first electromagnetic field generator connected to the frame, a second electromagnetic field generator connected to the frame on an opposite side of the tubular from the first electromagnetic field generator, first and second sensors positioned with respect to the frame so as to be movable between a first position away from the tubular and a second position in proximity to the tubular, and a tubular conveyor cooperative with the frame for moving the tubular in a helix path along a longitudinal axis of the tubular toward and through the frame. The first and second sensors are suitable for detecting flux leakage from the magnetic flux field generated by the electromagnetic field generators.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to the electromagnetic flux leakage inspection of tubulars. More particularly, the present invention relates to apparatus and methods whereby a fixed frame contains the electromagnetic flux generators and sensors relative to a tubular translatably passed therethrough.

### BACKGROUND OF THE INVENTION

Continuous tubular strings formed of connectable tubular sections or elements, such as production tubing strings, strings of drill pipe and casing strings, are used in the drilling, completion and production of subterranean oil and gas wells. The tubular elements comprising such strings are subject to mechanical damage when the tubular elements are located within the well and are also subject to the action of corrosive fluids which may be contained within the tubular elements or which may be transported through the tubular string between the well surface and a downhole location. It is therefore advantageous that the individual tubular elements comprising a tubular string be inspected periodically. Commonly, tubular elements or tubular sections are inspected for defects after the tubing string is removed from the well. Conventional inspection of tubular sections normally occurs to the individual tubing sections comprising the tubing string. Defect inspections are conventionally performed on a section-by-section basis.

A number of techniques exist for determining the presence of a defect in a tubing section. For example, the precise location of internal and external radially extending and three-dimensional defects, including slug inclusions, mechanical damage, corrosion pitting and fatigue cracks, has been determined by flux leakage techniques in which a longitudinal magnetic field is induced by one or more magnetic induction coils. Surface riding detectors are located around the tubing and the maximum signal is recorded to precisely locate the defect.

A common way of detecting longitudinal defects magnetically is the “rotating pole” method, where the magnetic field is applied from the outside by rotating electromagnets and where detectors positioned in-between the poles scan the outside surface of the pipe. Tubing wall thickness has been measured by measuring the radiation from an external rotating radioactive source of gamma radiation transmitted through the wall of a tubing section to a detector positioned inside the pipe. Other ways of measuring wall thickness with gamma radiation, which are backscatter, double-wall through-transmission and chord, have both the radiation detector and the source located on the outside of the pipe.

One technique for inspecting tubular elements which is adaptable to relative movement, at variable velocities, is a technique involving the use of a saturating longitudinal magnetic field and the subsequent measurement of the time integral of the electrical signal caused by the magnetic field applied to the ferromagnetic tubular member to determine the average wall thickness. Testing using this technique has been conducted for surface pipe installations in which the magnetic field and the flux detecting elements are moved relative to a continuous pipe array.

Electromagnetic inspection systems are known which have been used to locate flaws and defects in tubular goods. Typically, the electromagnetic inspection system uses sensors to detect magnetic flux leakage which occurs when a discontinuity is present in the tubular wall section. Conventionally, the sensors rotate around the tubular in a fixed rotating housing as the tubular is conveyed linearly through the rotating housing by conventional conveying means. The rotating sensors maintain contact with the surface of the tubular during inspection activities. The magnetic field is introduced into the tubular by electromagnets contained in the rotating detector housing or by a residual magnetic field magnetizing means prior to the tubular entering the rotating detector assembly. The use of electromagnets attached within the rotating detection housing requires the use of slip rings and brushes to convey the electrical power to the electromagnets that are located 180 degrees apart in the rotating housing. The electromagnets are positioned 90 degrees from each of the two sensors which are themselves positioned opposite to each other in the rotating detection housings. The electromagnets are mounted within the rotating assembly at a fixed distance from the tubular outside diameter surface. Metal shim plates are attached to the electromagnets in order to adjust the electromagnet's pole face to within close proximity to the tubular outside diameter surface. These metal shim plates will vary in thickness in order that the shim plate pole face will be within close proximity to the tubular outside surface in order that a sufficient magnetic field for inspection detector sensitivity is introduced into the tubular wall thickness section. The close proximity distance of the electromagnetic shimmed pole face is not sufficient to allow passage of a tubular with large outside diameter upset connections. This is important since tubulars with large upset connections are used extensively in oil and gas drilling operations worldwide. The electromagnets are positioned in such a manner that will cause the resultant magnetic fields generated by each electromagnet to add to the total resultant magnetic field. A total resultant magnetic field is enhanced by aligning the center axis of each of the electromagnetic coils. The total resultant field is further optimized by positioning one electromagnetic coil to produce a north/south magnetic field and positioning the other magnetic coil to produce a south/north magnetic field. The electromagnetic coils do not contact the tubular surface, but are maintained in close proximity to the tubular surface in order to maintain an optimum magnetic field in the tubular wall sections.

The use of the residual circumferential magnetic field applied to each tubular prior to entering the rotating detector assembly eliminates the need for electromagnets in the rotating housing. The residual circumferential magnetic field is induced into the tubular wall by inserting a magnetizing rod through the full length of the internal diameter of the tubular. A cable is attached to each end of the magnetizing rod which is protruding from each end of the tubular. The cables are attached to a capacitor discharge system or a battery pack discharge unit. Such capacitor discharge systems or battery pack discharge units are commercially available. The capacitor discharge system or battery pack discharge unit is suitably activated. The residual circumferential residual magnetic field that is generated 360 degrees into the tubular wall is utilized for detection of longitudinally-oriented flaws or defects in the test object.

When utilizing either the electromagnets or the residual circumferential magnetic method described above, slip rings are necessary for conveying the signal from the sensors contained within the rotating frame for interpretation by inspection personnel. The use of either the electromagnets or the residual circumferential magnetic methods described hereinabove also requires that the linear tubular conveyer requires that both speed of the conveyor and rotating velocity (rpm) be controlled and synchronized in order that the resultant helical path of the sensors provides 100% or more of inspection coverage. Also, the use of the electromagnets or the residual method requires the rotating assembly to be balanced by distributing the detectors and/or electromagnets opposite to each other.

FIG. 1 illustrates such a prior art system of electromagnetic inspection. As can be seen in FIG. 1, the rotating inspection housing 10 contains non-adjustable electromagnets 12 and 13. The electromagnets 12 and 13 are rotated about a linearly conveyed non-rotating tubular 11. The electromagnets 12 and 13 are fitted with detachable shim plates 15 and 17. Shim plates 15 and 17 are attached to the pole face of the electromagnets 12 and 13, respectively, in order that the pole face is within close proximity to the outer surface of the tubular 11. The electromagnets 12 and 13 are electrically activated by way of slip rings and slip ring brushes 18 as the inspection housing 10 is rotated around the linearly conveyed non-rotating tubular 11. It can be seen that the inspection flux leakage detectors 14 and 16, which are contained in the rotating inspection housing 10, are mounted 90° relative to the electromagnets 12 and 13 so as to detect electromagnetic flux leakage 19 when a longitudinally-oriented flaw or defect 21 is present within the tubular 11. The electromagnetic flux lines 20 remain with the wall 24 of the tubular 11 unless a longitudinally-oriented flaw 21 is present. The rotating detectors 14 and 16 remain in contact with the outside surface of the tubular 11 during the inspection process. The detection signal generated by a flaw or defect 21 is conveyed from the inspection detectors 14 and 16 via slip ring and slip ring brushes 18 to an inspection processor in a manner known in the art.

It can be seen in FIG. 1 that a small air gap 22 is maintained between the electromagnets 12 and 13 and the outside surface of the tubular 11 in order to allow the electromagnets to not grab the tubular 11 or slow the rotating housing or tubular conveyance. The air gap 22 is changed for different outside diameters of the tubular 11 by use of the detachable shim pole plates 15 and 17. The shim pole plates 15 and 17 are manually changed when the outside diameters of the tubular 11 are changed. The electromagnets 12 and 13 and the shim pole plates 15 and 17, respectively, do not open and close. As a result, when the tubular 11 has large upset connections, the tubular 11 cannot be properly inspected.

In the past, a variety of patents have issued with respect to the electromagnetic inspection of tubulars and other objects. For example, U.S. Pat. No. 4,096,437, issued on Jun. 20, 1978 to Kitzinger et al., describes a magnetic testing device for detecting loss of metallic area in internal and external defects in elongated objects. The testing device includes a permanent magnet assembly having poles adapted to be spaced apart in the longitudinal direction of the elongated object for inducing a longitudinal magnetic flux in a section of the object between the poles of the magnet assembly. This flux is strong enough to saturate each section of the object. A tubular pole piece is substantially centered on the elongated object adjacent each pole of the permanent magnet assembly for directing the magnetic flux radially into the object at one pole and out of the object at the other pole. Hall effect devices are spaced around at least one pole piece in the path of the magnetic flux for sensing the radial flux entering into the elongated object. Means are provided for sensing the variations of such magnetic flux as an indication of loss of metallic area in the object.

U.S. Pat. No. 4,101,832, issued on Jul. 18, 1978 to Baker et al., provides a multiprobe eddy current flaw detection device having a suitable means for raising and lowering the individual probes. A plurality of pickup arms are mounted in spaced relation with respect to each other around a work path and a plurality of sensing coils are carried by each of the pickup arms. The pickup arms are each mounted on a support member to pivot on an axis transverse to the direction of the work path so that the sensing coils may be moved into proximity and around the circumference of a workpiece as the workpiece travels along the work path.

U.S. Pat. No. 4,379,261, issued on Apr. 5, 1983 to K. M. Lakin, shows a rotating magnetic field device for detecting cracks in metal. This device has input signal coils on cores radially arranged around a center and having outer ends of the cores which rest against a surface of a metal assembly to be tested for defects. The input coils are energized by an AC signal of different phase for each respective coil so that a rotating magnetic field is produced in the assembly being tested. An output sensor coil is mounted at the center of the tester immediately adjacent to such test surface for coupling out a signal induced from the rotating field.

U.S. Pat. No. 4,492,115, issued on Jan. 8, 1985 to Kahil et al., describes a method and apparatus for measuring defects in ferromagnetic tubing. A saturating magnetic field and a fluctuating magnetic field are applied to the tubing. The magnitude of the induced fields and the changes are measured to quantify defects in the tubing. U.S. Pat. No. 4,636,727, issued on Jan. 13, 1987, is another patent by Kahil et al., which describes a similar process for detecting and locating the defects in tubular sections. U.S. Pat. No. 4,710,712, issued on Dec. 1, 1987 to Bradfield et al., also describes a similar system for the use of a saturating magnetic field for the detection of defects in tubing. U.S. Pat. No. 4,792,756, issued on Dec. 20, 1988 to Lam et al., also a slight variation on the previous patents issued to Kahil et al. and to Bradfield et al. U.S. Pat. No. 5,157,977, issued on Oct. 27, 1992 to R. C. Grubbs, teaches an apparatus for feeding, indexing, testing, and storing tubular goods. This machine uses the eddy current test method to test the outer surface, the inner surface, and internal and external threads of the tubular. The pipe is spun during the examination so that the sensors of the inner and outer surfaces, when driven, trace a helical pattern on the pipe.

U.S. Pat. No. 5,377,553, issued on Jan. 3, 1995 to W. H. Knepper, Jr., describes a transducer support device that is employed with magnet flux leak detector so as to render the detector sufficiently compact and lightweight to facilitate the use thereof at the wellhead of an oil well so as to avoid lay-down horizontal inspection at a location away from the wellhead.

U.S. Pat. No. 5,442,278, issued on Aug. 15, 1995 to Kammann et al., teaches a method and apparatus for detecting magnetic discontinuities by inducing a magnetic field into a magnetizable sample. The apparatus includes an electric motor, a transmission, driven transport wheels, and non-driven transport wheels. The apparatus includes a magnetic for inducing a magnetic field in the sample. A sensor unit detects magnetic stray flux from the magnetic field induced in the sample and converts the detected magnetic stray flux into a signal for processing by a signal processor.

U.S. Pat. No. 5,600,069, issued on Feb. 4, 1997 to Girndt et al., provides an ultrasonic testing apparatus and method for multiple diameter oilfield tubulars. The apparatus includes four ultrasonic arrays each containing a plurality of individual watertight ultrasonic transducers. Axially adjustable ultrasonic arrays include axially spaced sockets for controlling an axial movement thereof to discrete positions associated with each selected range of diameters to be tested. During scanning, the tubular is moved axially and rotationally with respect to an ultrasonic testing apparatus to provide a helical scan pattern along the length of the tubular.

U.S. Pat. No. 5,793,205, issued on Aug. 11, 1998 to Griffith et al., describes a coil and guide system for eddy current examination of pipe. This apparatus includes an eddy current coil adapted to removably circumferentially surround the pipe. The coil includes a cable having a plurality of conductors adapted to form a continuous conductor coil when the cable is circumferentially wrapped around the pipe.

U.S. Pat. No. 6,249,119, issued on Jun. 19, 2001 to Curtis et al., teaches a rotating electromagnetic field defect detection system for tubular goods. This system includes an encircling coil for providing a saturating DC magnetic field the to tubular. An encircling drive coil applies a low level AC field using three-phase AC. Encircling pick up coils within the AC drive coils detect uniform, time-varying magnetic fields in order to reveal defects within the tubular passing through the system.

U.S. Pat. No. 6,271,670, issued on Aug. 7, 2001 to T. W. H. Caffey, describes a method and apparatus for detecting external cracks from within a metal tube. A continuous electromagnetic wave from a transverse magnetic-dipole source with a coaxial electric-dipole receiver is used for the detection of the external side wall cracks and other anomalies in boiler tubes.

It is an object of the present invention to provide an apparatus and method that allows for the locating of longitudinally-oriented discontinuities or flaws in a test object.

It is another object of the present invention to provide a non-rotating inspection assembly for the inspection of tubulars.

It is another object of the present invention to provide a method and apparatus for electromagnetic flaw detection which avoids the use of slip rings and brushes.

It is a further object of the present invention to provide an electromagnetic flaw detection apparatus which allows tubulars with the large upsets to be inspected.

It is a further object of the present invention to provide an electromagnetic flaw detection apparatus and method that is suitable for accommodating tubulars of different diameters.

It is a further object of the present invention to provide an electromagnetic flaw detection apparatus that completely covers the length of tubular without gaps in the inspection.

It is a still another object of the present invention to provide an electromagnetic flaw detection apparatus which is easy to use and relatively inexpensive.

These and other objects and advantages of the present invention will become apparent from the reading of the attached specification and appended claims.

### BRIEF SUMMARY OF THE INVENTION

The present invention is an electromagnetic flaw detection apparatus for inspection of a tubular. The apparatus comprises a frame having an interior suitable for receiving a diameter of the tubular therein. This frame is non-rotatable. A first electromagnetic field generating means is connected to the frame. A second electromagnetic field generating means is also connected to the frame and arranged to be positioned on an opposite side of a tubular passing through the frame from the first electromagnetic field generating means. The first and second electromagnetic field generating means serve to generate a circumferentially-oriented magnetic flux field relative to the tubular passing therebetween. A first sensor is positioned with respect to the frame so as to be movable between a first position away from the tubular and a second position in proximity to the tubular. A second sensor is positioned with respect to the frame so as to be movable between a first position away from the tubular and a second position in proximity to the tubular. Each of the first and second sensors are suitable for detecting flux leakage from the magnetic flux field generated by the first and second electromagnetic field generating means. A tubular conveyance means is cooperative with the frame for moving the tubular in a helix path along a longitudinal axis of the tubular toward and through the frame.

In the present invention, the first and second sensors are arranged so as to be on opposite sides of the tubular passing through the frame. Each of the first and second sensors are offset by approximately 90° from the first and second electromagnetic field generating means.

The first electromagnetic field generating means includes a first electromagnet affixed to the frame and extending inwardly into the interior of the frame. The second electromagnetic field generating means includes a second electromagnet affixed to the frame and extending inwardly into the interior of the frame. A first fluid-actuated cylinder is connected to the frame and to the first electromagnet so as to move the first electromagnet between a position away from the tubular and a second position in proximity to the tubular. A second fluid-actuated cylinder is also connected to the frame and to the second electromagnet so as to move the second electromagnet between a first position away from the tubular and a second position in proximity to the tubular. In particular, in one embodiment of the present invention, a first guide rod is affixed to the frame and extends thereacross. A first guide arm is slidably connected to this first guide rod and fixedly connected to the first electromagnet. A second guide arm is slidably connected to the first guide rod and is also fixedly connected to the second electromagnet. A second guide rod is affixed to the frame and extends thereacross in generally parallel relationship to the first guide rod. A third guide arm is slidable connected to the second guide rod and is fixedly connected to the first electromagnet. A fourth guide arm is slidably connected to the second guide rod and is fixedly connected to the second electromagnet.

In the present invention, a first fluid-activated cylinder is connected to one side of the frame and to the first sensor so as to selectively move the first sensor between the first and second positions. A second fluid-activated cylinder is connected to an opposite side of the frame and to the second sensor so as to selectively move the second sensor between the first and second positions.

A translating means is connected to the frame so as to non-rotatably translate the frame with respect to the tubular passing therethrough so as to allow the sensors and electromagnets to be utilized in association with different diameters of pipe. The tubular conveyance means provides the tubular with a helix path width. This helix path width is no greater than 90° of the length of the sensor.

The present invention is also a method of electromagnetically inspecting longitudinally-oriented discontinuities in a tubular that comprises the steps of: (1) forming a frame having an electromagnet affixed thereto and a sensor translatably mounted thereto; (2) passing the tubular along a helix path along a longitudinal axis of the tubular and into an interior of the frame; (3) moving the sensor into close proximity with an exterior surface of the tubular; (4) applying a circumferentially-oriented magnetic flux field by the electromagnetic onto the tubular as the tubular passes adjacent to the electromagnet; and (5) sensing flux leakage from the tubular from the magnetic flux field applied by the electromagnet.

In this method of the present invention, the step of forming includes forming a frame so as to have a first electromagnet and a second electromagnet extending inwardly from opposite sides of the frame and forming the frame so as to have a first sensor and second sensor extending inwardly from opposite sides of the frame. The first and second sensors are positioned approximately 90° from the first and second electromagnets. In the method of the present invention, electromagnets are moved into proximity with an exterior surface of the tubular as the tubular passes into the frame. The frame can be non

[symbol]

### BRIEF DESCRIPTION OF THE SEVERAL VIEWS OF THE DRAWINGS

FIG. 1 is an end view of an electromagnetic flaw detection apparatus in accordance with the prior art.

FIG. 2 is an end view of the preferred embodiment of the electromagnetic flaw detection apparatus of the present invention.

FIG. 3 is a side elevational view of the electromagnetic flaw detection of FIG. 2.

FIG. 4 is a plan view of the electromagnetic flaw detection apparatus of FIG. 2.

FIG. 5 is an end view showing an alternative view of the electromagnetic flaw detection apparatus of the present invention

FIG. 6 is an end view of the alternative embodiment of FIG. 5 showing, in particular, the use of the alternative embodiment in association with a tubular having an upset formed thereon.

FIG. 7 is a plan view of the alternative embodiment of FIG. 5 illustrating the use of the present invention in association with an upset of a tubular.

FIG. 8 is a plan view of the alternative embodiment of the present invention, as illustrated in FIG. 6, showing the use of the present invention in association with an upset of a tubular.

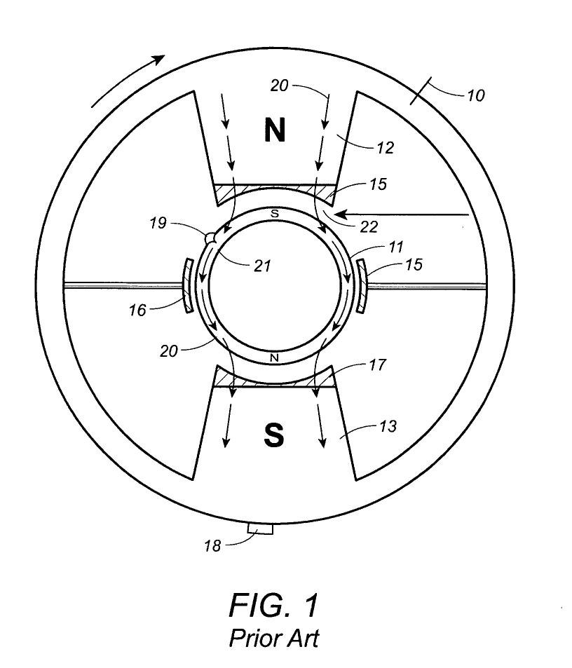

### DETAILED DESCRIPTION OF THE INVENTION

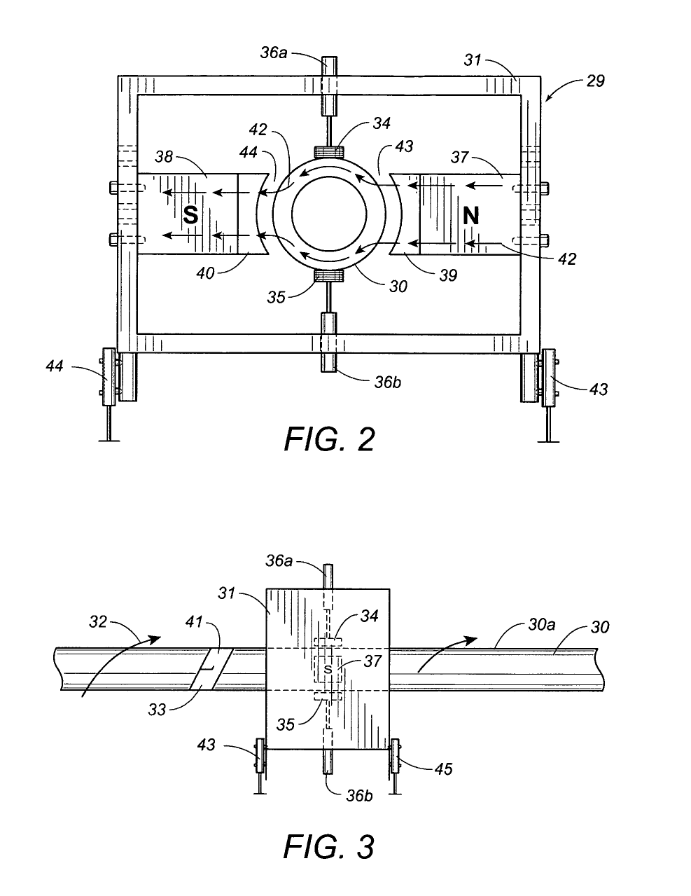

Referring to FIG. 2, there is shown the electromagnetic flaw detection apparatus 29 in accordance with the preferred embodiment of the present invention. The electromagnetic flaw detection apparatus 29 includes a non-rotating inspection frame 31. A first electromagnet 37 is affixed to one side of the frame 31 and extends inwardly therefrom. A second electromagnet 38 extends inwardly from an opposite side of the frame 31. A first fluid-activated cylinder 36a is affixed to the frame 31 and extends inwardly therefrom. A second fluid-activated cylinder 36b is affixed to an opposite side of the frame 31 from fluid-activated cylinder 36a and also extends inwardly therefrom. The tubular 30 is illustrated as extending between the electromagnets 37 and 38 and the fluid-activated cylinders 36a and 36b. It can be seen that the fluid-activated cylinder 36a has a detector 34 that is placed into close proximity to the outer wall of the tubular 30. The fluid-activated cylinder 36b has a detector 35 that is placed into proximity with an outer surface of the tubular 30 on an opposite side of the tubular 30 from the detector 34. As will be described hereinafter, the frame 31 has a fluid-activated cylinder 36a that is suitable for moving the detector 34 between a first position away from the tubular 30 and a second position in proximity to the tubular 30. Similarly, the frame 31 has a cylinder 36b that is suitable for moving the detector 35 from a position away from the tubular 30 to a position in proximity to the outer surface of the tubular 30.

In FIG. 2, it can be seen that the electromagnets 37 and 38 are wired directly to electrical power. The electromagnets 37 and 38 include pole face shims 39 and 40, respectively. The pole face shims 39 and 40 are attached to the electromagnets 38 and 37 to within close proximity of the outer diameter of the tubular 30 which requires inspection. The inspection detectors 34 and 35 are placed 90° from the electromagnets 37 and 38. The electromagnetic field flux 42 crosses the air gap 43 from the electromagnet 37, enters the tubular 30, and exits across air gap 44 into the electromagnet 38. Cylinders 43 and 44 can raise and lower the frame 31 in order to adjust the frame 31 to accommodate different outside diameters of various tubulars.

In FIG. 3, it can be seen that the tubular 30 is illustrated as being moved through the frame 31. It can be seen that the detectors 34 and 35 are positioned by the respective cylinder 36a and 36b into close proximity with the outer diameter 30a of the tubular 30. The electromagnet 37 is illustrated as located between the detectors 34 and 35. For the purposes of illustration, the electromagnet 37 is actually 90° from each of the detectors 34 and 35 relative to the longitudinal axis of the tubular 30.

The present invention utilizes a conveyance method of the prior art to cause the tubular 30 to move through a non-rotating inspection assembly. The tubular conveyer causes the tubular 30 to helix in the forward or reverse direction along the longitudinal axis of the tubular 30. Each of the individual rollers of the conveyer is set at the same inclination angle relative to the longitudinal axis of the tubular to allow for a helix path 32 throughout the entire length of the conveyer. By changing the inclination of the conveyance rollers the helix 32 can be easily reset for different sizes of the outer diameter 30a. The individual roller, can be individually adjusted by using a marked indexing alignment method or by an adjustment rod connected in common to all of the individual rollers contained in the conveyance device. Once all of the rollers are set and locked into position, the helix path 32 can be verified manually by using a mounted paint stick tracing device which lowers the paint stick into contact with the helixing tubular 30. The distance between the traced paint stick marks on the outer surface 30a of the tubular 30 is measured along and parallel to the longitudinal axis of the tubular 30 and can be verified to assure a proper helix path required for 100% plus inspection coverage. In FIG. 3, it can be seen that the helix path width 33 is maintained at no greater than 90° of the length of the detectors 34 and 35. This achieves 100% plus inspection coverage for longitudinally-oriented flaws or defects, such as defect 41. As was described hereinbefore, the inspection detectors 34 and 35 are opened and closed around outer surface 30a of the tubular 30 by utilizing air or hydraulic cylinders 36a and 36b.

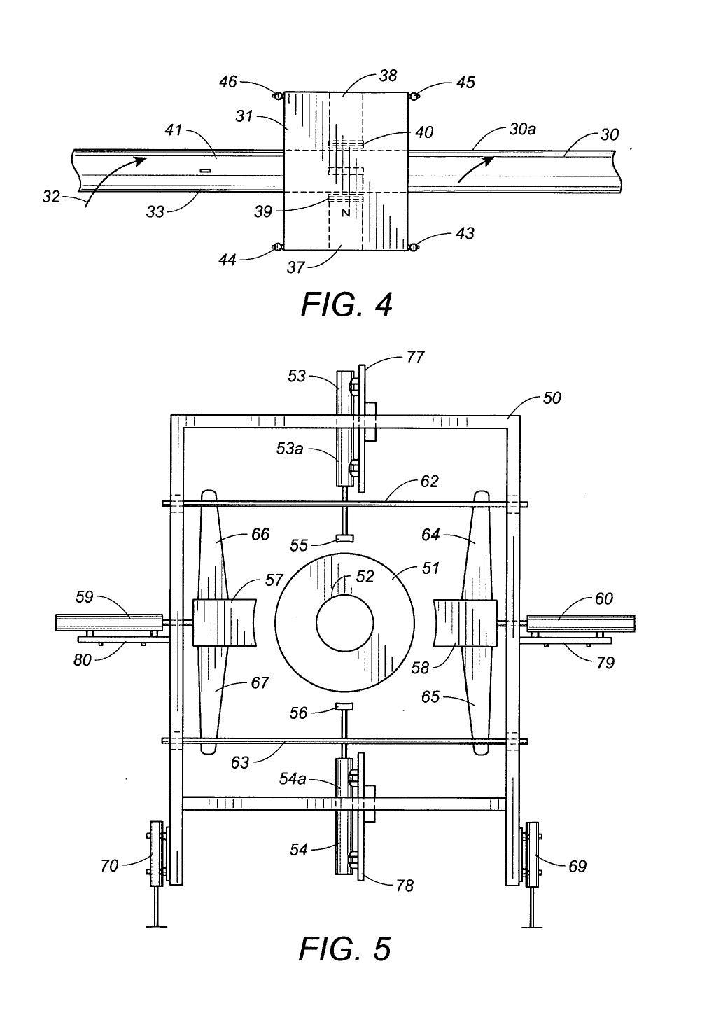

FIG. 4 illustrates how the electromagnets 37 and 38 are placed into close proximity to the outer surface 30a of the tubular 30. The detector 34 is illustrated as positioned between the electromagnets 37 and 38. Pole face shims 39 and 40 are illustrated in FIG. 4 as being placed in close proximity to the outer surface 30a of tubular 30.

As can be seen in FIG. 4, there are cylinders 43, 44, 45 and 46 that are connected to the various corners of the frame 31. These cylinders 43, 44, 45 and 46 raise and lower the inspection frame 31 in order to adjust the frame 31 to accommodate different tubular outside diameters.

Referring to FIG. 5, there is shown the electromagnetic flaw detection apparatus 49 in accordance with an alternative embodiment of the present invention. The apparatus 49 includes a frame 50 having a configuration somewhat similar to that of the previous embodiment. In FIG. 5, it can be seen that a tubular 52 has a large outside diameter upset connection 51 located at an end thereof. The tubular 52 is helixed by the conveyer described hereinabove and through the non-rotating frame 50. The frame 50 can be raised or lowered by hydraulic cylinders 69 and 70. Additional hydraulic cylinders, not shown, are provided at the opposite end of the frame 50 from hydraulic cylinders 69 and 70. The hydraulic cylinders 69 and 70 are utilized so as to raise and lower the frame 50 in order that the centerline of the electromagnets 57 and 58 are aligned with the centerline of the upset 51 of the tubular 52. It can be seen in FIG. 5 that the electromagnets 57 and 58 are extended and/or retracted by fluid-actuated cylinders 59 and 60, respectively. The movement of the electromagnets 57 and 58 through the use of the fluid-actuated cylinders 59 and 60, allows for the passage of the large diameter upset 51 of tubular 52. The electromagnets 57 and 58 are mounted within the frame 50 on guide rods 62 and 63. The electromagnet 58 has guide arm 64 affixed thereto and slidably mounted on the guide rod 62. The electromagnet 58 also has guide arm 65 extending in an opposite direction from guide 64 and slidably connected to the guide 63. The guide rod 62 is in generally parallel relationship to the guide rod 63. The electromagnet 57 also includes guide arms 66 and 67 which extend outwardly therefrom in opposite directions. Guide arms 66 and 67 are also slidably mounted onto the guide rods 62 and 63. The use of the guide arms 64, 65, 66 and 67 stabilizes the electromagnets through cooperation with the guide rods 62 and 63. Guide rods 62 and 63 extend across the frame 50 and are fixedly mounted thereto.

In FIG. 5, it can further be seen that the fluid-actuated cylinder 60 is mounted onto a plate 79 extending outwardly on one side of the frame 50. The fluid-actuated cylinder 59 is mounted on a plate 80 that extends fixedly outwardly from the frame 50. Plates 79 and 80 provide stability for the fluid-actuated cylinders 60 and 59, respectively. The fluid-actuated cylinders 59 and 60 can be either air or hydraulic cylinders.

In FIG. 5, a cylinder 53 and a cylinder 54 are mounted on opposite sides of the tubular 52. The cylinder 53 is mounted to the frame 50 through the use of a mounting plate 77. Similarly, the cylinder 54 is connected to the plate 50 through the use of a mounting plate 78. The cylinder 53 has detector 55 positioned so as to be in proximity to the upset 51 of the tubular 52. Similarly, the cylinder 54 includes the detector 56 and is also mounted in proximity to an opposite side of the upset 51 of tubular 52. The fluid-actuated cylinder 53 allows the detector 55 to move between a position in proximity to the upset 51 and a position away from the upset 51. Similarly, the fluid-actuated cylinder 54 allows the detector 56 to move between a position in proximity to the upset 51 and a position away from the upset 51. The movement of the detectors 55 and 56, along with the electromagnets 57 and 58, allows the large diameter upset 51 to easily pass through the frame.

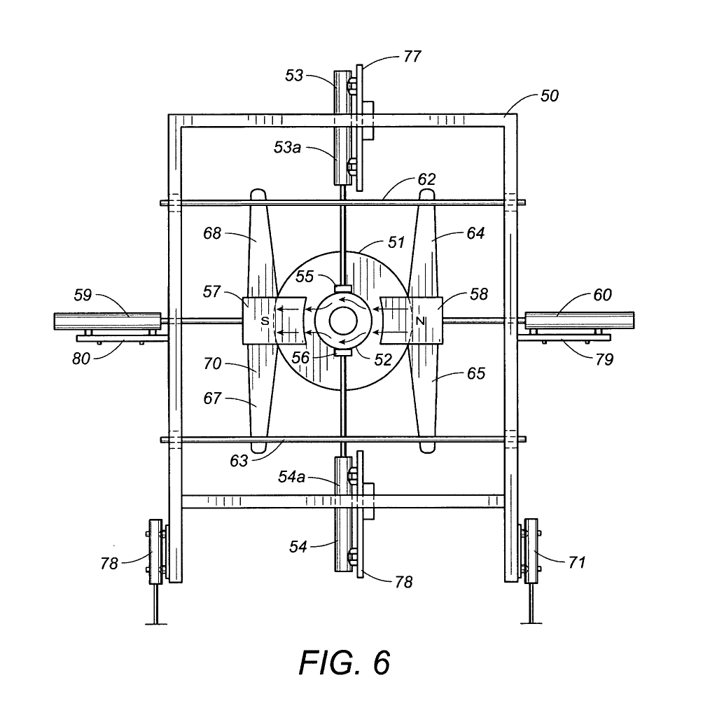

In FIG. 6, it can be seen that once the large upset 51 has moved past the electromagnets 57 and 58, the fluid-actuated cylinders 59 and 60 activate to close the electromagnets 57 and 58 to within close proximity to the smaller diameter of the tubular 52. In FIG. 6, once the large upset 51 has moved past the inspection detectors 55 and 56, then cylinders 53 and 54 activate to close the inspection detectors 55 and 56 onto the smaller diameter portion of the tubular 52.

Referring to FIG. 6, it can be seen that the tubular upset 51 and the tubular 52 helix through the frame 50 with a helix path 1. The electromagnets 57 and 58 are illustrated as closed as are the inspection detectors 55 and 56. The closed electromagnets 57 and 58 are activated to induce an electromagnetic flux field 61 from the electromagnets 58 across the air gap 69 and into the wall 75 of the tubular 52 and then across the air gap 70 and into the electromagnet 57. The closed inspection detectors 55 and 56, which are in contact with the outer surface of the tubular 52, will detect flux leakage from longitudinal flaws or defects present in the tubular 52.

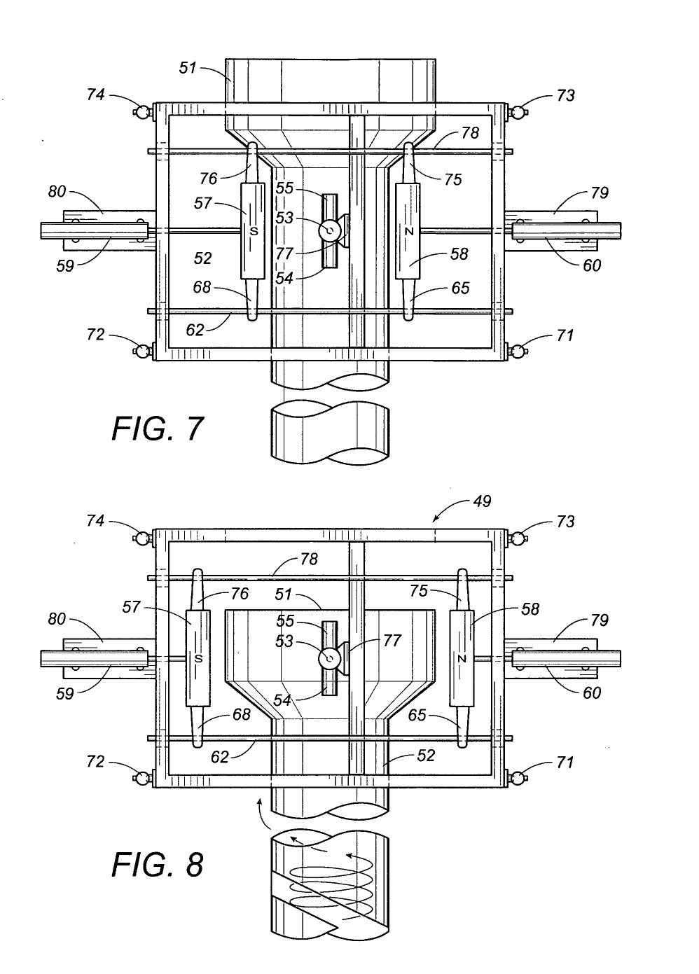

Referring to FIG. 7, the large upset 51 will helix forward into the inspection frame 50. Cylinders 59 and 60 have retracted and opened the respective electromagnets 58 and 57 by way of the guide arms 65, 66, 75 and 76 which are attached to guide rods 62 and 78. Also, in FIG. 7, it can be seen that the cylinders 53 and 54 have retracted and opened the inspection detectors 55 and 56 in order to allow the large upset 51 to pass forward into the inspection frame 50. The various mounting plates 77, 78, 79 and 80 can contain proper bolt slots which are used to adjust respective cylinders in order to accommodate various diameters of the tubular 52.

In FIG. 8, it can be seen that once the large upset 51 has helixed past the electromagnets 57 and 58, the fluid-actuated cylinders 59 and 60 activate to close the electromagnets 57 and 58 to within close proximity to the small diameter of tubular 52. In FIG. 8, once the large upset has moved past the inspection detectors 55 and 56, then the cylinders 53 ad 54 activate to close the inspection detectors 55 and 56 onto the smaller diameter portion of the tubular 52.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. An electromagnetic flaw detection apparatus for inspection of a tubular, the apparatus comprising:
a frame having an interior suitable for receiving a diameter of the tubular therethrough, said frame being non-rotatable;
a first electromagnetic field generating means connected to said frame;
a second electromagnetic field generating means connected to said frame, said first and second electromagnetic field generating means arranged so as to be positioned on opposite sides of the tubular passing through the frame, said first and second electromagnetic field generating means for generating a circumferentially-oriented magnetic flux field relative to the tubular passing therebetween;
a first sensor positioned with respect to said frame so as to be movable between a first position away from the tubular and a second position in proximity to the tubular;
a second sensor positioned with respect to said frame so as to be movable between a first position away from the tubular and a second position in proximity to the tubular, said first and second sensors suitable for detecting flux leakage from the magnetic flux field generated by said first and second electromagnetic field generating means; and
a tubular conveyance means cooperative with said frame for moving the tubular in a helix path along a longitudinal axis of the tubular toward and through said frame.

2. The apparatus of claim 1, said first and second sensors being arranged on opposite sides of the tubular passing through the frame.

3. The apparatus of claim 2, said first and second sensors being offset by approximately 90° from said first and second electromagnetic field generating means.

4. The apparatus of claim 1, said first electromagnetic field generating means comprising a first electromagnet affixed to said frame and extending interior of said frame, said second electromagnetic field generating means comprising a second electromagnet affixed to said frame and extending inwardly of said interior of said frame.

5. The apparatus of claim 1, each of said first and second sensors having a length dimension, said tubular conveyance means for providing the tubular with a helix path width, said helix path width being no greater than 90% of said length dimension of said sensor.

6. The apparatus of claim 1, further comprising:
a first fluid-activated cylinder connected to one side of said frame and to said first sensor so as to selectively move said first sensor between said first and second positions; and
a second fluid-activated cylinder connected to an opposite side of said frame and to said second sensor so as to selectively move said second sensor between said first and second positions.

7. The apparatus of claim 1, further comprising:
a translating means connected to said frame so as to non-rotatably translate said frame relative to the tubular passing therethrough.

8. The apparatus of claim 4, further comprising:
a first fluid-actuated cylinder connected to said frame and to said first electromagnet so as to move said first electromagnet between a first position away from the tubular and a second position in proximity the tubular; and
a second fluid-actuated cylinder connected to said frame and to said second electromagnet so as to move said second electromagnet between a first position away from the tubular and a second position in proximity to the tubular.

9. The apparatus of claim 8, further comprising:
a first guide rod affixed to said frame and extending thereacross;
a second guide arm slidably connected to said first guide rod and fixedly connected to said first electromagnet; and
a second guide arm slidably connected to said first guide rod and fixedly connected to said second electromagnet.

10. The apparatus of claim 9, further comprising:
a second guide rod affixed to said frame and extending thereacross, said second guide rod in generally parallel relationship to said first guide rod;
a third guide arm slidably connected to said second guide rod and fixedly connected to said first electromagnet; and
a fourth guide arm slidably connected to said second guide rod and fixedly connected to said second electromagnet.

11. An electromagnetic flaw detection apparatus for inspection of a tubular, the apparatus comprising:
a frame having an interior suitable for receiving a diameter of the tubular therethrough, said frame being non-rotatable;
a first sensor connected to said frame so as to extend into close proximity to the tubular passing through the frame;
a second sensor connected to said frame so as to extend into close proximity to the tubular passing through the frame sensor;
a first electromagnet connected to the frame so as to be movable between a first position away from the tubular and a second position in proximity to the tubular; and
a second electromagnet connected to said frame so as to movable between a first position away from the tubular and a second position in proximity to the tubular, said first and second sensors suitable for detecting a flux leakage from a magnetic flux field generated by the first and second electromagnets.

12. The apparatus of claim 11, said first and second sensors being offset by approximately 90° from said first and second electromagnets.

13. The apparatus of claim 11, said first sensor positioned with respect to said frame so as to be movable between a first position away from the tubular and a second position in proximity to the tubular, said second sensor positioned with respect to said frame so as to be movable between a first position away from the tubular and a second position in proximity to the tubular.

14. The apparatus of claim 11, further comprising:
a tubular conveyance means cooperative with said frame for moving a tubular in a helix path along a longitudinal axis of the tubular toward and through the frame.

15. The apparatus of claim 11, further comprising:
a first fluid-actuated cylinder connected to said frame and to said first electromagnet so as to move said first electromagnet between said first position and said second position; and
a second fluid-actuated cylinder connected to said frame and to said second electromagnet so as to move said second electromagnet between said first position and said second position.

16. A method of electromagnetically inspecting longitudinally-oriented discontinuities and flaws in a tubular comprising:
forming a frame having an electromagnet affixed thereto and a sensor translatably mounted thereto;
passing the tubular along a helix path along a longitudinal axis of the tubular and into an interior of the frame;
moving said sensor into close proximity with an exterior surface of the tubular;
applying a circumferentially-oriented magnetic flux field by said electromagnet onto the tubular as the tubular passes adjacent to said electromagnet; and
sensing flux leakage by said sensor from the tubular from the magnetic flux field applied by the electromagnet.

17. The method of claim 16, said step of forming comprising:
forming said frame so as to have a first electromagnet and a second electromagnet extending inwardly from opposite sides of said frame; and
forming said frame so as to have a first sensor and second sensor extending inwardly from opposite sides of said frame, said first and second sensors positioned approximately 90° from said first and second electromagnets.

18. The method of claim 16, further comprising:
moving said electromagnet into proximity with an exterior surface of the tubular as the tubular passes into said frame.

19. The method of claim 16, further comprising:
non-rotatably translating into said frame into a desired position relative to a diameter of the tubular.

20. The apparatus of claim 16, said sensor having a length dimension, said step of passing the tubular comprising:
moving the tubular with a helix path width no greater than 90% of said length dimension of said sensor.
